(19) United States
(12) Patent Application Publication
(10) Pub. No.: US 2008/0104333 A1
(43) Pub. Date: May 1, 2008

(54) TRACKING OF HIGHER-LEVEL CACHE CONTENTS IN A LOWER-LEVEL CACHE

(76) Inventor: Judson E. Veazey, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/554,690

(22) Filed: Oct. 31, 2006

(51) Int. Cl. G06F 13/28

(52) U.S. Cl. 711/141

(57) ABSTRACT

A cache memory system is provided which includes a higher-level cache, a lower-level cache, and a bus coupling the higher-level cache and the lower-level cache together. Also included is a directory array coupled with the lower-level cache. The lower-level cache is configured to track all of the data contents of the higher-level cache in the directory array without duplicating the data contents in the lower-level cache.

### BACKGROUND

Computer systems typically utilize a cache memory system to improve the performance and throughput of the computer system by reducing the apparent time delay or latency normally associated with a processor accessing data in a main memory. A cache memory system employs one or more caches, each including a cache memory in conjunction with control logic. Generally, each of the cache memories is smaller and faster than the main memory, so that a processor may access a copy of data from a cache more quickly and readily than from the main memory. Moreover, many cache memory systems use more than one level of cache between a processor and the main memory to further enhance computer system operation.

One important function of the cache memory system is to provide “cache coherency.” In other words, each copy of the same memory address of the main memory should hold the same value throughout the cache memory system so that the entire address space of the system remains consistent throughout. To maintain cache coherency, the cache memory system utilizes a cache coherency protocol involving the transfer of messages or some other form of communication between the various caches. This communication may occur among caches of the same level, as well as between caches residing at different levels of the cache memory system. Unfortunately, use of the protocol normally results in a significant amount of communication overhead between caches.

In some systems, the amount of communication overhead is reduced by enforcing “cache-inclusiveness” between cache levels, meaning the entire contents of a higher-level cache are replicated in the next lower-level cache. As a result, the higher-level cache propagates any changes therein to the next-lowest cache level, thus reducing the amount of negotiation, and hence communication, between the levels. Unfortunately, cache-inclusiveness also requires significant amounts of redundant storage in lower-level caches to duplicate the data contents in the caches at the next higher level. As a consequence, the lowest cache level must hold the data contents residing in all other (i.e., higher) cache levels. Also, the more levels of cache that are implemented in a system, the higher the quantity of content replication. Thus, since cache memories tend to be relatively expensive on a per-byte basis, cache-inclusiveness tends to be an expensive method for reduction of cache coherency protocol communication overhead.

### BRIEF DESCRIPTION OF THE DRAWINGS

FIG. 1 is a block diagram of a cache memory system according to an embodiment of the invention.

FIG. 2 is a flow diagram of a method for operating a cache memory system according to an embodiment of the invention.

FIG. 3 is a block diagram of a cache memory system according to another embodiment of the invention.

FIGS. 4A-4G present a flow diagram of a method for operating the cache memory system of FIG. 3 according to another embodiment of the invention.

### DETAILED DESCRIPTION

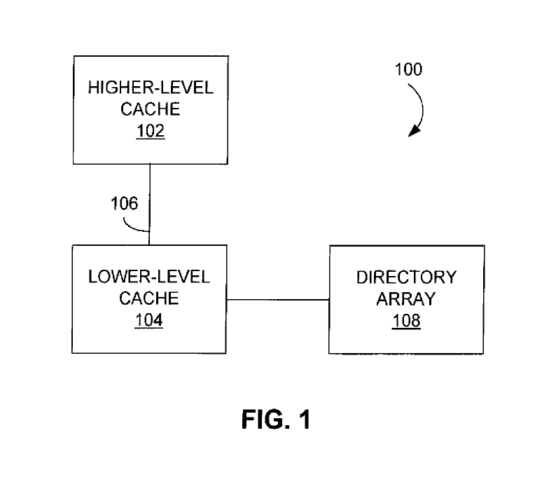

FIG. 1 illustrates one embodiment of the invention: a cache memory system 100 including a higher-level cache 102 and a lower-level cache 104. Coupling the higher-level cache 102 and the lower-level cache 104 is a bus 106. In one embodiment, data and protocol communication occurs over the bus 106. Also coupled with the lower-level cache 104 is a directory array 108. Generally, the lower-level cache 104 is configured to track all data contents of the higher-level cache 102 in the directory array 108 without duplicating the data contents in the lower-level cache 104.

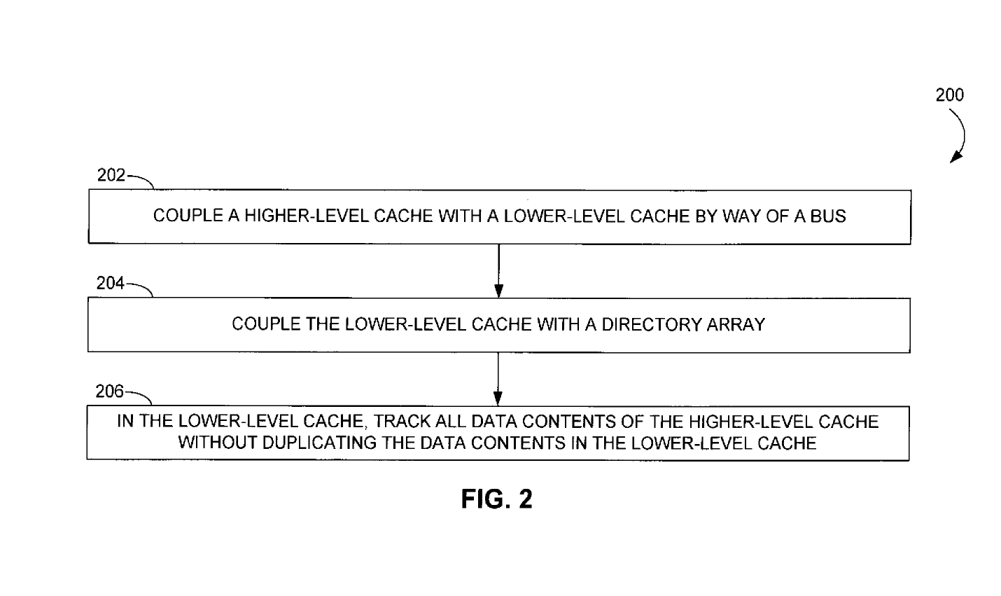

Similarly, FIG. 2 provides a flow diagram of a method 200 of configuring and operating a cache memory system, such as the cache memory system 100 of FIG. 1. First, a higher-level cache is coupled with a lower-level cache by way of a bus (operation 202). Also, the lower-level cache is coupled with a directory array (operation 204). In the lower-level cache, all data contents of the higher-level cache are tracked in the directory array without duplicating the data contents in the lower-level cache (operation 206).

Another embodiment of the invention—a cache memory system 300—is shown within a computer system 301. The computer system 301 includes four central processing units (CPUs) 302, 304, 306, 308 and a main memory 326, with the cache memory system 300 positioned therebetween. Other components, such as I/O devices, device interfaces, user interfaces, cache controllers, and the like, are not shown to simplify and facilitate the discussion of the cache memory system 300 presented below.

The cache memory system 300 includes a set of higher-level caches 310, 312, 314, 316, each of which is accessible to one of the CPUs 302, 304, 306, 308, respectively. In one implementation, each of the higher-level caches 310-316 is a level-three (L3) cache included within the CPU 302-308. Higher-level caches L1 and L2 (not shown) are also included within each of the CPUs 302-308, but are not discussed below.

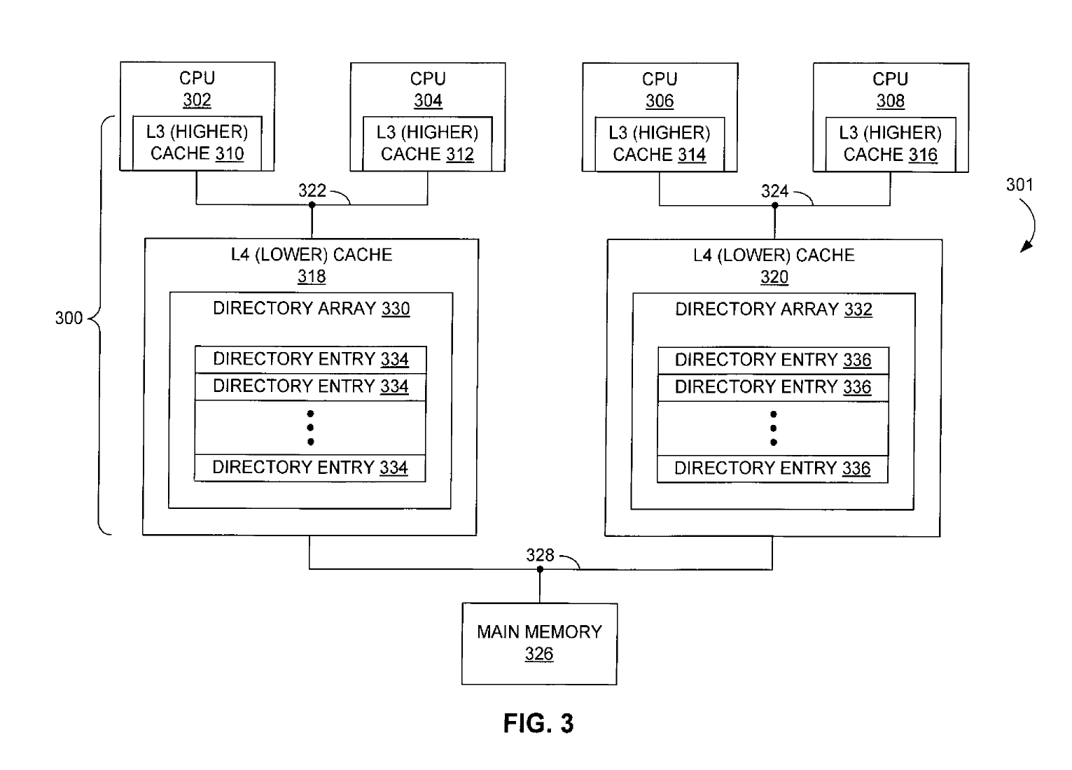

Also included in the cache memory system 300 are two lower-level caches 318, 320. In the embodiment of FIG. 3, each of the lower-level caches is a level-four (L4) cache residing external to the CPUs 302-308 and immediately below the L3 caches 310-316 in the hierarchy of the cache memory system 300. Logically below the lower-level caches 318, 320 resides the main memory 326. In other embodiments, the main memory 326 may exist as separate and disjoint portions of memory, each of which is logically identified with one of the CPUs 302-308.

In FIG. 3, the first lower-level cache 318, the first higher-level cache 310 and the second higher-level cache 312 are coupled together by way of a first bus 322. In this particular embodiment, the first bus 322 is an upper front-side bus allowing the first CPU 302 and the second CPU 304 to communicate through their respective higher-level caches 310, 312 with each other and with the first lower-level cache 318. The first lower-level cache 318 is also coupled by way of a second bus 328 to the main memory 326. In one embodiment, the second bus 328 is termed a lower front-side bus.

Also in FIG. 3, a third bus 324 couples together the second lower-level cache 320, the third higher-level cache 314, and the fourth higher-level cache 316. Similar to the first bus 322, the third bus 324 is an upper front-side bus allowing the third CPU 306 and the fourth CPU 308 to communicate through their corresponding higher-level caches 314, 316 with each other and with the second lower-level cache 320. Further, the second bus 328 allows the second lower-level cache 320 to communicate with the main memory 326 and the first lower-level cache 318.

The specific computer system 301 of FIG. 3 is described in conjunction with various embodiments of the invention discussed below. However, a virtually unlimited number of different computer system configurations, each employing a different number of CPUs, caches, cache levels, and buses in a wide variety of configurations may be employed while incorporating embodiments of the invention as described in greater detail here.

Each of the lower-level caches 318, 320 includes, and is coupled with, a directory array 330, 332, respectively. In one embodiment, each directory array 330, 332 is stored within the cache memory (not shown explicitly in FIG. 3) or associated tag array (also not depicted in FIG. 3) of its corresponding lower-level cache 318, 320. The directory array 330, 332 may instead be implemented as a separate memory array located within its lower-level cache 318, 320 in another example. In another implementation, the directory array 330, 332 lies external to its lower-level cache 318, 320.

The first directory array 330 includes a number of directory entries 334, while the second directory array 332 holds a number of directory entries 336. Each entry 334 of the first directory array 330 includes the system memory space address of a cache line stored within one or both of the first two higher-level caches 310, 312 coupled via the first bus 322 with the first lower-level cache 318. Also, the capacity of the first directory array 330 should be large enough to hold a number of directory entries 334 equal to the number of cache lines storable in the first two higher-level caches 310, 312 combined. In an analogous manner, each entry 336 within the second directory array 332 includes the memory space address of a cache line located within one or both of the second two higher-level caches 314, 316 coupled via the third bus 324 with the second lower-level cache 320. Similar to the first directory array 330, the capacity of the second directory array 332 should be large enough to hold a number of directory entries 336 equal to the number of cache lines storable in the second two higher-level caches 314, 316 combined.

Typically, the number of bits required to represent a memory space address for a cache line is less than the number of bits for the complete address of a particular location in the main memory 326, since each cache line normally includes a number of contiguous memory locations. For example, if each cache line comprises 128 bytes, and each byte is individually addressable in the main memory 326, then each cache line address is seven bits less in width than a full memory address, since 2⁷ equals 128. Typically, the cache line address represents the most significant bits of the memory address, so that the bottom seven bits of the memory address are not represented in the cache line address in this example.

Each entry 334, 336 of a directory array 330, 332 may also include other information, such as one or more status bits describing the associated directory entry 334, 336. For example, in the case of the first lower-level cache 318, the status bits of a particular entry 334 may indicate which of the higher-level caches 310, 312 coupled with the first lower-level cache 318 over the first bus 322 includes a copy of the cache line indicated in the entry 334. In other embodiments, other status bits may be associated with each entry 334, 336 as well.

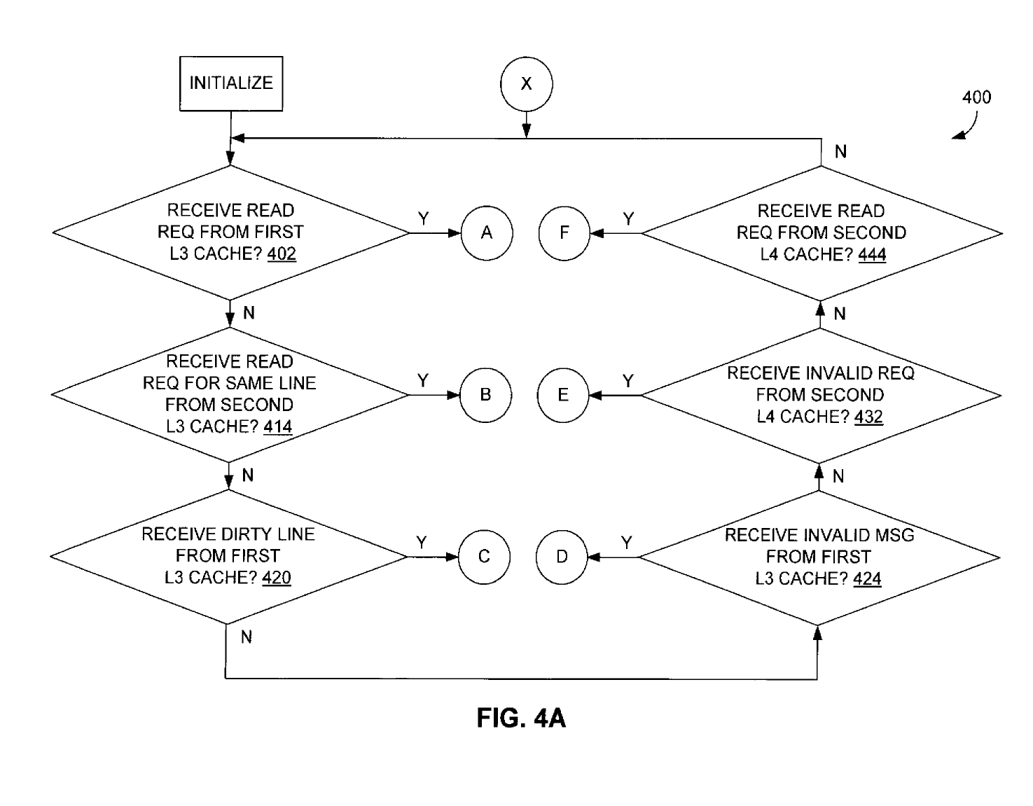

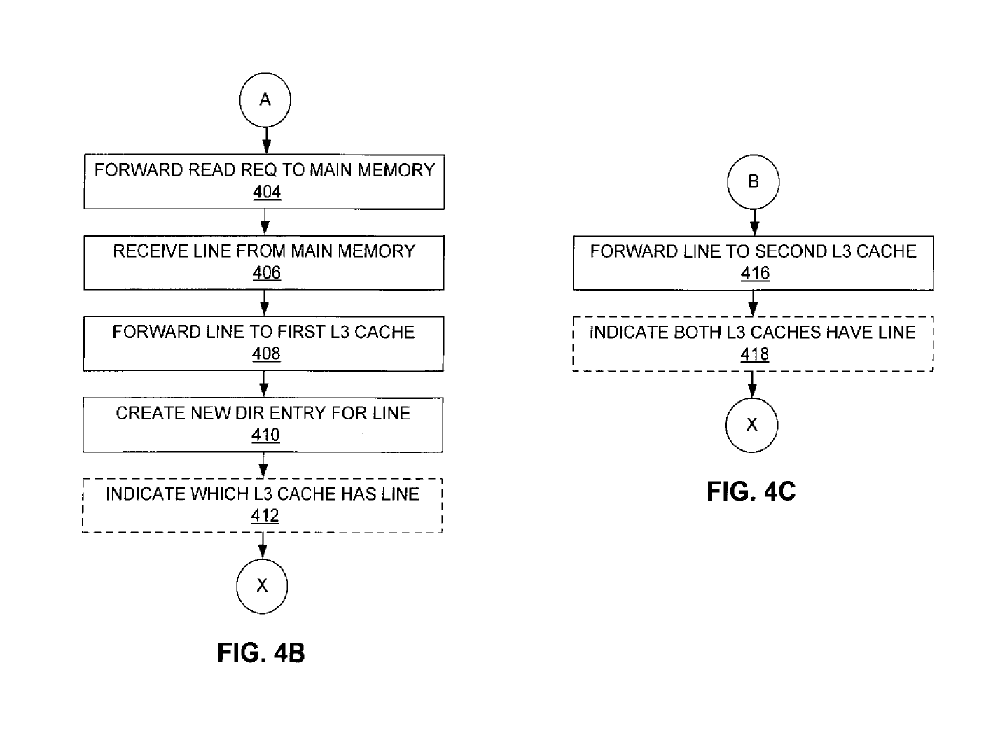

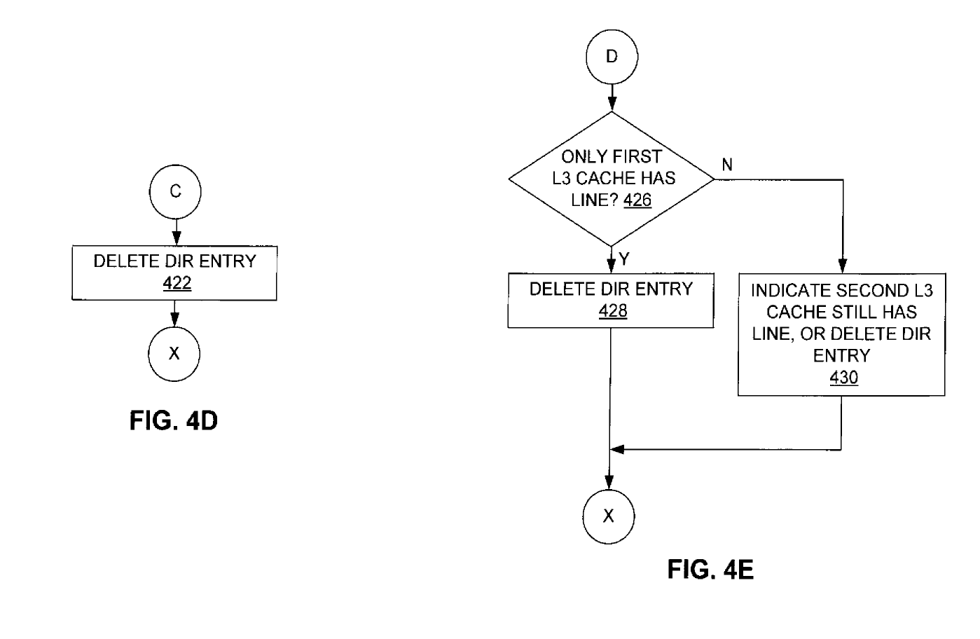

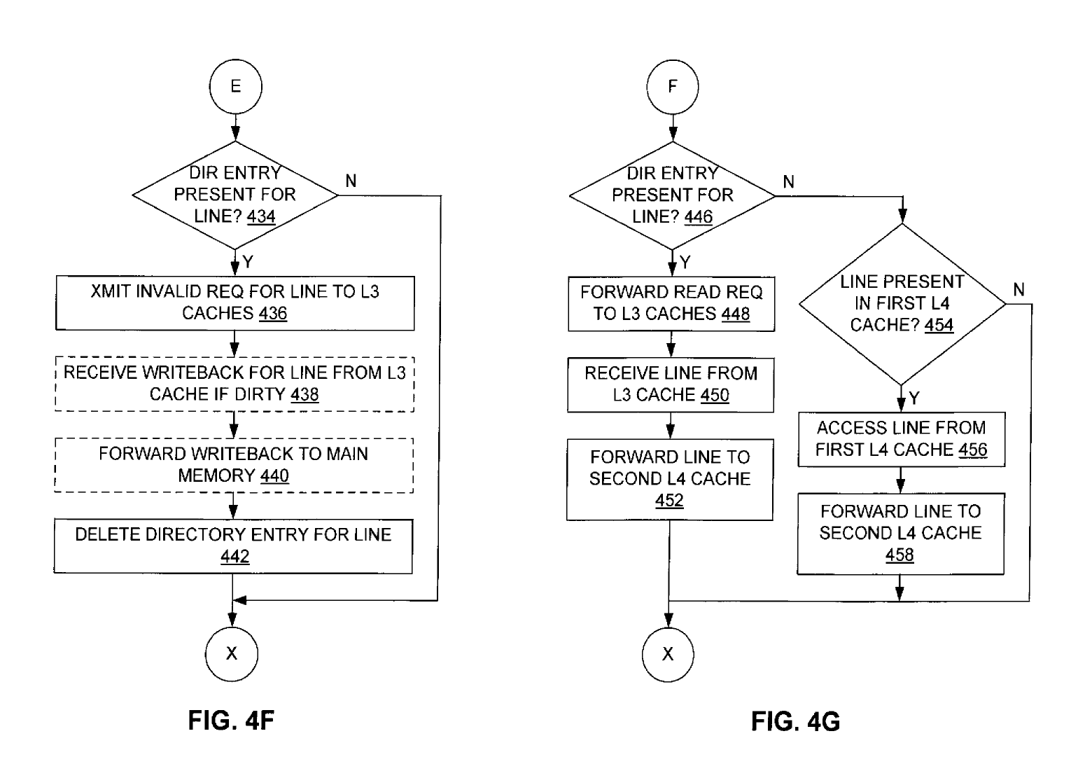

FIGS. 4A-4G (collectively, FIG. 4) provide a flow diagram of a method 400 of operating the cache memory system 300, focusing on various operations of the first lower-level cache 318 in conjunction with its associated directory array 330 to facilitate brevity and simplicity. Accordingly, the operations of FIG. 4 do not provide an exhaustive list of all operations undertaken by the first lower-level cache 318 or any other part of the system, but instead provide examples pertaining to embodiments of the invention. Further, this discussion is equally applicable to the second lower-level cache 320 and its directory array 332.

Upon initialization of the computer system 301, each of the caches 310-320 presumably is empty. Thus, the directory array 330 of the first lower-level cache 318 effectively contains no entries 334, as neither of the first two higher-level caches 310, 312 contain any valid cache lines. Presuming then that the first lower-level cache 318 receives a read request from the first CPU 302 through its higher-level cache 310 over the first bus 322 (operation 402), the empty lower-level cache 318 forwards the read request to the main memory 326 over the second bus 328 (operation 404). Once the first lower-level cache 318 receives a cache line including the requested data from the main memory 326 over the second bus 328 in response to the read request (operation 406), the first lower-level cache 318 forwards the cache line to the first higher-level cache 310 over the first bus 322 for the first CPU 302 to access (operation 408), and also creates a new directory entry 334 in its directory array 330 for the new cache line (operation 410). If status bits for the new entry 334 are also available, the entry 334 may also indicate in which of the higher-level caches 310, 312 contains the cache line (operation 412).

If, at some later time, the first lower-level cache 318 receives a read request for data in the same cache line from the second CPU 304 through its higher-level cache 312 (operation 414) over the first bus 322, the first lower-level cache 318 forwards the cache line to the second higher-level cache 312 over the bus 322 (operation 416). In addition, the first lower-level cache 318 updates the directory entry 334 of the cache line to indicate that the line is now present in both the first higher-level cache 310 and the second higher-level cache 312, if status bits are available within the entry 334 (operation 418).

At times, cache lines are purged or invalidated from either or both of the higher-level cache memories 310, 312, thus causing the lower-level cache 318 to update the appropriate entries 334 of its directory array 330. For example, if the first lower-level cache 318 receives a “dirty,” or modified, cache line from the first higher-level cache 310 over the first bus 322 to ultimately be written back to the main memory 326 (operation 420), the lower-level cache 318 deletes the directory entry 334 for that cache line from its directory array 330 (operation 422). Typically, the lower-level cache 318 may delete the entry 330 unconditionally, as cache coherency protocols normally require that only one cache at any level possess a dirty cache line.

In another example, the first higher-level cache 310 may instead invalidate a “clean,” or unmodified, cache line which may also be held within the second higher-level cache 312. Such an event may occur, for example, in response to a capacity fault in the first higher-level cache 310. As part of this operation, the first lower-level cache 318 receives an invalidate message for the cache line in the first higher-level cache 310 as part of the cache coherency protocol (operation 424). The response of the first lower-level cache 318 to the invalidate message may then depend on the type of information maintained in the status bits of the directory entry 334 associated with that cache line. Presuming these status bits possess the capacity to identify which of the first two higher level caches 310, 312 hold the cache line, the response may depend on whether the second higher-level cache 312 also holds a copy of the cache line. For example, if the status bits of the associated directory entry 334 indicate that only the first higher-level cache 310 held the cache line (operation 426), the first lower-level cache 318 deletes the entry 334 from the directory array 330 (operation 428). Otherwise, if both of the first two higher-level caches 310, 312 hold the cache line prior to the invalidate message, the second higher-level cache 312 may be able to ignore the message. Under this scenario, the first lower-level cache 318 may employ the status bits of the entry 334 for the cache line to indicate that the cache line is no longer held in the first higher-level cache 310, but is still present in the second higher-level cache 312 (operation 430). However, if the second higher-level cache 312 is not configured to ignore such an invalidate message, the first lower-level cache 318 is free to delete the entry 334 for the cache line after the associated cache line in the second higher-level cache 312 is invalidated. Alternatively, if the status bits of the associated directory entry 334 only indicate whether the cache line is stored in a higher-level cache 310, 312, but do not indicate which higher-level cache 310, 312 holds the line, the entry 334 is deleted and the second higher-level cache 312 invalidates its corresponding cache line, if valid.

Presuming the first lower-level cache 318 has maintained its directory array 330 in such a manner, the lower-level cache 318 may use the information therein to efficiently process protocol messages from the second lower-level cache 320 received over the second bus 328. For example, the first lower-level cache 318 may receive an invalidate request over the second bus 328 (operation 432), indicating that a particular cache line should be invalidated in the first lower-level cache 318 and its corresponding higher-level caches 310, 312. In response, the first lower-level cache 318 checks for an entry 334 for the cache line in its directory array 330 (operation 434). If an entry 334 is present, the first lower-level cache 318 transmits an invalidate request referencing the cache line over the first bus 322 to the first and second higher-level caches 310, 312 (operation 436); otherwise, the transmission of an invalidate request over the first bus 322 is unnecessary, thus reducing the amount of protocol communication traffic over the first bus 322. If the particular cache line is dirty, the higher-level cache 310, 312 storing the cache line will issue an implicit writeback command back over the first bus 322 to be received by the first lower-level cache 318 (operation 438), which the first lower-level cache 318 forwards to the main memory 326 (operation 440). In any event, the first lower-level cache 318 then deletes the entry 334 from its directory array 330 (operation 442).

In another situation, the first lower-level cache 318 may receive a read request for a particular cache line over the second bus 328 from the second lower-level cache 320 to access the most recent copy of the data (operation 444). In response, the first lower-level cache 318 checks its directory array 330 for an entry 334 for the cache line (operation 446). If so, a copy of the data resides in one or both of the first and second higher-level caches 310, 312, and thus the first lower-level cache 318 forwards the read request over the first bus 322 (operation 448). Thereafter, the first lower-level cache 318 receives the cache line returned in response to the read request by either the first or second higher-level cache 310, 312 (operation 450), and forwards the data to the second lower-level cache 320 over the second bus 328 (operation 452). However, if no entry 334 exists in the directory array 330 for the requested cache line, the first lower-level cache 318 need not request the data from the first two higher-level caches 310, again reducing communication overhead over the first bus 322. Instead, the first lower-level cache 318 may determine, such as by way of its own cache tags, that the cache line is present therein (operation 454). If so, the first lower-level cache 318 accesses the data from its own cache memory (operation 456), and transfers the data to the second lower-level cache 320 via the second bus 328 (operation 458).

As described above, various embodiments of the present invention, by way of the interaction between a lower-level cache and its associated directory array, reduce the amount of protocol communication within a cache memory system, especially between the lower-level and next-higher-level caches, without incurring the full extent of the cache memory consumption penalty normally associated with a cache-inclusiveness solution. Using the computer system 301 of FIG. 3 as an example, presume that each of the higher-level caches 310-316 have a capacity of 8 megabytes (MB), for a total of 16 MB coupled with each of the lower-level caches 318, 320. Also presume that each of the lower-level caches 318, 320 possesses a capacity of 32 MB. If each cache line is 128 bytes in length, then each pair of higher-level caches 310, 312 and 314, 316 possesses a total capacity of (16 MB/128 bytes), or 128K cache lines. Therefore, each of the lower-level caches 318, 320 must provide a capacity of 128K directory entries. Further presuming that a full memory space address for the computer system 301 is 40 bits in length, each cache line address or tag is 40-7, or 33, bits in length, since each cache line is 2⁷, or 128, bytes. Thus, each directory array 330, 332 should provide a maximum capacity of 33 bits multiplied by 128K directory entries, or about 528 KB, not including any additional status bits. In contrast, when employing cache-inclusiveness, each of the lower-level caches 318, 320 must allocate a maximum of 16 MB of its storage space to duplicate the valid contents of its higher-level cache 310, 312 or 314, 316. Therefore, in the extreme, implementation of this particular embodiment results in an approximately 32-fold decrease in the memory requirements of each of the lower-level caches 318, 320 over a cache-inclusiveness strategy. Thus, the use of directory arrays reduces protocol communication overhead while consuming significantly fewer memory resources than an implementation of a cache-inclusiveness scheme.

While several embodiments of the invention have been discussed herein, other embodiments encompassed by the scope of the invention are possible. For example, while some embodiments of the invention are described above in reference to a specific computer system architecture, many other computer architectures, including multiprocessor schemes, such as symmetric multiprocessor (SMP) systems, may employ various aspects of the invention. Also, while specific numbers, levels, and sizes of caches are presumed above for illustrative purposes, each of these characteristics may be varied greatly in other embodiments. Also, aspects of one embodiment may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims.

What is claimed is:

1. A cache memory system, comprising:
a first higher-level cache;
a first lower-level cache;
a first bus coupling the first higher-level cache with the first lower-level cache; and
a directory array coupled with the first lower-level cache;
wherein the first lower-level cache is configured to track all data contents of the first higher-level cache in the directory array without duplicating the data contents in the first lower-level cache.

2. The cache memory system of claim 1, wherein the first lower-level cache comprises the directory array.

3. The cache memory system of claim 1, wherein the first lower-level cache comprises a cache memory, wherein the cache memory comprises the directory array.

4. The cache memory system of claim 1, wherein the first lower-level cache memory comprises a tag array, wherein the tag array comprises the directory array.

5. The cache memory system of claim 1, wherein:
the first higher-level cache is an L3 cache; and
the first lower-level cache is an L4 cache.

6. The cache memory system of claim 1, wherein the directory array comprises directory entries, wherein each directory entry comprises a memory space address of a cache line of the first higher-level cache.

7. The cache memory system of claim 6, wherein each directory entry further comprises a status of the cache line.

8. The cache memory system of claim 6, wherein the first lower-level cache is further configured to receive a first cache line from the first higher-level cache over the first bus to be written to a main memory, and, in response, delete the directory entry for the first cache line.

9. The cache memory system of claim 6, wherein the first lower-level cache is further configured to receive an invalidate message for a first cache line from the first higher-level cache over the first bus, and, in response, delete the directory entry for the first cache line.

10. The cache memory system of claim 6, further comprising:
a main memory; and
a second bus coupling the main memory with the first lower-level cache;
wherein the first lower-level cache is further configured to read data for a first cache line from the main memory over the second bus, forward the first cache line to the first higher-level cache over the first bus, and create a new directory entry for the first cache line.

11. The cache memory system of claim 10, further comprising:
a second higher-level cache coupled with first bus;
wherein the first lower-level cache is further configured to receive a read request for the first cache line over the first bus; in response, forward the first cache line to the second higher-level cache over the first bus; and update the directory entry for the first cache line to indicate that the first cache line resides in both the first and second higher-level caches.

12. The cache memory system of claim 11, wherein the first lower-level cache is further configured to receive an invalidate message for the first cache line from the first higher-level cache over the first bus and, in response, update a status of the directory entry for the first cache line to indicate that the first cache line is absent from the first higher-level cache and present in the second higher-level cache.

13. The cache memory system of claim 10, further comprising:
a second lower-level cache coupled with the second bus;
wherein the first lower-level cache is further configured to receive an invalidate request for the first cache line from the second lower-level cache over the second bus, and, in response, if the directory entry for the first cache line exists in the directory array, transmit an invalidate request for the first cache line over the first bus and delete the directory entry for the first cache line.

14. The cache memory system of claim 10, further comprising:
a second lower-level cache couple with the second bus;
wherein the first lower-level cache is further configured to receive a read request for the first cache line from the second lower-level cache over the second bus, and, in response, if the directory entry for the first cache line exists in the directory array, forward the read request for the first cache line over the first bus, receive data for the read request from the first bus, and forward the data to the second lower-level cache over the second bus; otherwise, determine if the data is present in the first lower-level cache, and, if so, transfer the data to the second lower-level cache over the second bus.

15. A method for configuring and operating a cache memory system, comprising:
coupling a first higher-level cache with a first lower-level cache by way of a first bus;
coupling the first lower-level cache with a directory array; and
in the first lower-level cache, tracking all data contents of the first higher-level cache in the directory array without duplicating the data contents in the first lower-level cache.

16. The method of claim 15, wherein the directory array comprises directory entries, wherein each directory entry comprises a memory space address of a cache line of the first higher-level cache.

17. The method of claim 16, wherein each directory entry further comprises a status of the cache line.

18. The method of claim 16, further comprising:
in the first lower-level cache, receiving a first cache line from the first higher-level cache over the first bus to be written to a main memory; and
in response, in the first lower-level cache, deleting the directory entry for the first cache line.

19. The method of claim 16, further comprising:
in the first lower-level cache, receiving an invalidate message for a first cache line from the first higher-level cache over the first bus; and
in response, in the first lower-level cache, deleting the directory entry for the first cache line.

20. The method of claim 16, further comprising:
coupling a main memory with the first lower-level cache by way of a second bus;
in the first lower-level cache, reading data for a first cache line from the main memory over the second bus;
in the first lower-level cache, forwarding the first cache line to the first higher-level cache over the first bus; and
in the first lower-level cache, creating a new directory entry for the first cache line.

21. The method of claim 20, further comprising:
coupling a second higher-level cache with the first bus;
in the first lower-level cache, receiving a read request for the first cache line over the first bus;
in response, in the first lower-level cache, forwarding the first cache line to the second higher-level cache over the first bus; and
in the first lower-level cache, updating the directory entry for the first cache line to indicate that the first cache line resides in both the first and second higher-level caches.

22. The method of claim 21, further comprising:
in the first lower-level cache, receiving an invalidate message for the first cache line from the first higher-level cache over the first bus; and
in response, in the first lower-level cache, updating a status of the directory entry for the first cache line to indicate that the first cache line is absent from the first higher-level cache and present in the second higher-level cache.

23. The method of claim 20, further comprising:
coupling a second lower-level cache with the second bus;
in the first lower-level cache, receiving an invalidate request for the first cache line from the second lower-level cache over the second bus;
in response, in the first lower-level cache, if the directory entry for the first cache line exists in the directory array, transmitting an invalidate request for the first cache line over the first bus and deleting the directory entry for the first cache line.

24. The method of claim 20, further comprising:
coupling a second lower-level cache with the second bus;
in the first lower-level cache, receiving a read request for the first cache line from the second lower-level cache over the second bus; and
in response, in the first lower-level cache, if the directory entry for the first cache line exists in the directory array, forwarding the read request for the first cache line over the first bus, receiving data for the read request from the first bus, and forwarding the data to the second lower-level cache over the second bus;
otherwise, in the first lower-level cache, determining if the data is present in the first lower-level cache, and, if so, transferring the data to the second lower-level cache over the second bus.

25. A cache memory system, comprising:
a higher-level cache;
a lower-level cache;
a first bus coupling the higher-level cache with the lower-level cache; and
means accessible to the lower-level cache for tracking all data contents of the higher-level cache without duplicating the data contents in the lower-level cache.
